(19) United States
(12) Patent Application Publication
(10) Pub. No.: US 2005/0012909 A1
(43) Pub. Date: Jan. 20, 2005

(54) Projection system with flexible orientation

(76) Inventors: Daniel E. Kokin, San Francisco, CA (US); Christopher Alexander, San Mateo, CA (US)

Correspondence Address: William J. Kolegraff, 3119 Turnberry Way, Jamul, CA, 91935, US

(21) Appl. No.: 10/784,464

(22) Filed: Feb. 23, 2004

Related U.S. Application Data
(60) Provisional application No. 60/449,362, filed on Feb. 21, 2003.

(51) Int. Cl. G03B 21/14; G03B 21/22; G03B 21/00

(52) U.S. Cl. 353/119; 353/70

(57) ABSTRACT

The projection system has a first base that orients the projector to project a video image along a first projection axis, and a second base that orients the projector to project a video image along a second projection axis. In one example of the projection system, the projection system projects a video image on a wall, and after a simple rotation, projects the video image on a ceiling. The projection system may also have an integral video player, such as a DVD, for providing a video source. The projection system may also have integral speakers, including a subwoofer, for providing quality audio to accompany the video image.

### BACKGROUND

The field of the present invention is large format entertainment systems. In particular, this invention relates to a large format entertainment system for residential use capable of projecting a video image.

Large format entertainment systems are constructed to bring a theater-like experience to the home. These systems have generally been available as either a direct view system or a projection system. A direct view system uses a large CRT for displaying the video image to the viewer. Although smaller direct view CRTs are moderately priced, the larger CRTs are quite expensive and bulky, even weighing several hundred pounds. Also, even the larger CRTs have size limitations. For example, it is unusual to find a CRT display system over 40 inches in diagonal width, and even a 40 in CRT does not provide a highly desirable theater-like experience. Because of the limitations of direct view systems, direct view systems have not gained widespread use as large format entertainment systems.

A better solution for large format entertainment is provided by projection systems. Projection systems are generally classified into rear projection systems and front projection systems. The rear projection systems have become quite popular world wide, due to their large screen size and video display quality. For example, it is possible to purchase a rear projection TV system that can be 60 inches to 70 inches in diagonal width for about the cost of a 35-inch direct view system. However, the rear projection video system is arranged in a single huge cabinet. In a typical home, the rear projection cabinet dominates any room in which it is positioned, and many people simply do not have enough room for such a large video component. Also, even though the rear projection unit may be moderately priced, it is often necessary to purchase expensive entertainment furniture to enable the cabinet to be aesthetically presented. In many cases, the entertainment furniture is far more expensive than the rear projection unit itself. Thus, the overall cost of ownership for the rear projection system may be quite high.

Finally, the large format entertainment system can be constructed as a front projection video system. The front projection video system has the advantage of being able to project to extremely large sizes, for example, over 120 inches diagonal width. Further, the front projection system has the projector separate from the screen, so the projector may be housed in a relatively small cabinet. The screen then may be either permanently or retractably mounted on a wall. When not in use, the front projection video system is unobtrusive. However, known front projection entertainment systems are very expensive, costing 4 or more times the cost of a rear projection system. Such a price puts known front projection systems out of the reach of a large portion of the home theater market. Further, the front projection video system is often complex to set up, and is typically complex to maintain. In this regard, the front projection video system requires continual maintenance and adjustments for optimal performance, which typically is done by an expensive trained technician.

Although there is a huge demand for bringing a theater-like experience into the home, present large format entertainment systems have failed to meet the needs of a large segment of the market. For example, smaller direct view TVs are reasonably affordable, but do not provide the big screen experience that many desire. Rear projection systems are reasonably priced and have large screens, but many do not have sufficient space to support the huge cabinets, and associated entertainment furniture can be prohibitively expensive. And finally the front projection entertainment systems are too expensive and too complex for the mass markets. All the large format systems discussed thus far all require relatively permanent installations, and do not afford the viewer an easy opportunity for moving the theater-experience to a new location. Such portability would increase the utility of a large format system.

Although not intended as a large format entertainment system, portable video projectors are now available. Business professionals primarily use these portable video projectors for making presentations to groups. These video projectors can weigh less than two pounds and easily connect to a laptop computer or even person digital assistant (PDA). These projectors take a video output from the laptop or PDA and project the resulting video image onto a screen for viewing. Portable video projectors are capable of generating very bright, high-resolution images even under bright and harsh ambient lighting conditions. Since the presenter often has little control over the ambient conditions in the room where the presentations will be made, it is important that the portable video projector has such capabilities. In fact, a major selling feature of most portable video projectors is the number of lumens they are capable of projecting. In constructing these portable video projectors, manufacturers often select very powerful illumination sources, such as metal-halide lamps, which must be replaced often and can cost hundreds of dollars. Also, the configuration and operation of these portable systems can be quite complex, and often companies have audiovisual specialist to assist business people in configuring and operating these devices.

### SUMMARY

It is therefore desirable to provide a new large format entertainment system that is easy to operate, affordable, and compact, while still providing a theater-like experience for the home viewer.

Briefly, the present invention provides a front projection system. The projection system has a first base that orients the projector to project a video image along a first projection axis, and a second base that orients the projector to project a video image along a second projection axis. In one example of the projection system, the projection system projects a video image on a wall, and after a simple rotation, projects the video image on a ceiling. The projection system may also have an integral video player, such as a DVD, for providing a video source. The projection system may also have integral stereo speakers, including a subwoofer, for providing quality audio to accompany the video image.

Advantageously, the disclosed front projection system provides a highly desirable large format entertainment system for residential use. For example, the projection system may provide video images having a diagonal width of 100 inches or more, depending on how the user arranges the projector in a room. The projection system is also easy to configure and operate, and is preferably packaged in a compact and transportable housing. Since the projection system uses readily available component parts, it is anticipated to be affordably priced. In one configuration, the projection system integrates a video player and speaker system, providing a complete theater-like experience in one self-contained unit.

### BRIEF DESCRIPTION OF THE DRAWINGS

FIGS. 1a and 1b show an illustration of a front projection system in accordance with the present invention;

FIGS. 2a, 2b, and 2c show an illustration of a front projection system in accordance with the present invention;

FIGS. 3a and 3b show more detail for the front projection system shown in FIGS. 2a and 2b;

FIGS. 4a (front view), 4b (side view), and 4c (other side view) show more detail for the front projection system shown in FIGS. 2a and 2b;

FIGS. 5a and 5b show an illustration of a front projection system in accordance with the present invention;

FIGS. 6a and 6b show an illustration of a front projection system in accordance with the present invention;

FIG. 7 shows a diagram of an optical system for a front projection system in accordance with the present invention;

FIG. 8 shows a functional block diagram for a front projection system in accordance with the present invention;

FIGS. 9a, 9b, and 9c show an illustration of a front projection system in accordance with the present invention; and

FIG. 10 shows a diagram of an optical system for a front projection system in accordance with the present invention;

### DETAILED DESCRIPTION

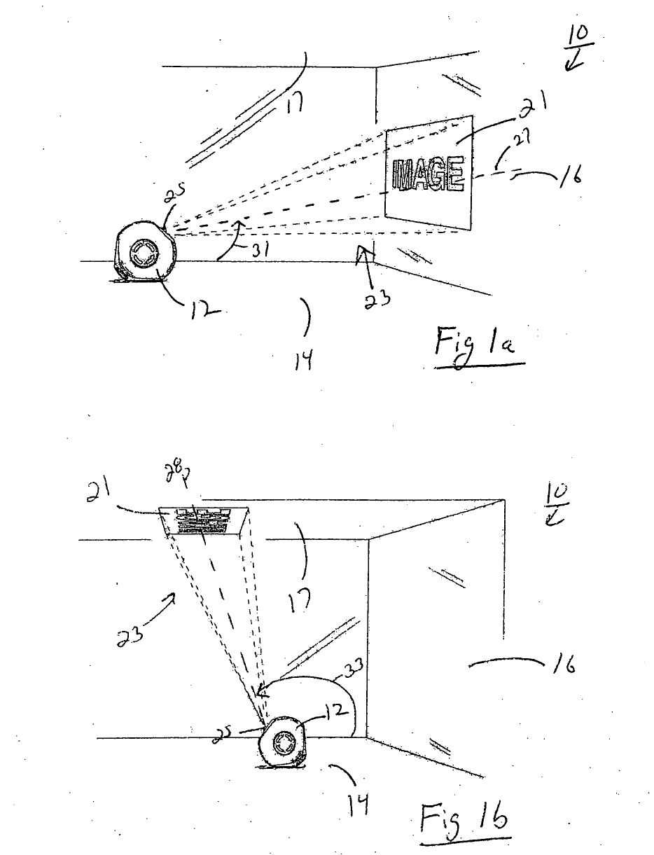

Referring now to FIG. 1, a projection system 10 is shown. Projection system 10 is a front projection system constructed to provide a large format entertainment experience. Projection system 10 is constructed to be particularly appealing to home or residential video users. In this regard, projection system 10 is provided in a single compact housing, is quite portable, is easy to configure and operate, and presents a high-quality video experience. Further, as will be more fully describe below, projection system 10 is constructed to provide a flexible orientation for video projection, a highly desirable characteristic for home or residential use. For ease of use, projection system 10 may be configured into either of two available orientations. It will be appreciated that more orientations may be offered in other projection systems consistent with this disclosure.

Projection system 10 is shown in the two preselected orientations. FIG. 1A shows the video projector 12 displaying an image onto a wall 16, while FIG. 1B shows the video projector 12 displaying an image onto the ceiling 17. Referring now to FIG. 1A in more detail, the projector 12 is shown resting upon a support surface, which in the illustration is the floor 14. The video projector 12 has a projection lens 24 which projects a video beam 23 onto a projection face, which in the illustration is the wall 16. The wall 16 thereby shows a video image 21 which may be seen by a viewer. The video beam 23 is projected along a projection axis 27, while the projection axis 27 is offset by a setoff angle 31. By providing a setoff angle, the image 21 is projected onto the wall 16 and elevated above the projection lens 25, thereby facilitating ease of viewing.

Referring now to FIG. 1B, the projector 12 has been rotated to rest on the floor 14 in a different orientation. In the second orientation the projection lens 25 projects the video beam 23 onto a different projection face, which in the illustration is a ceiling 17. The video beam 23 is projected along a projection axis 28 as the beam in projected to the ceiling. The projection axis 28 is offset by a setoff angle 33. In this way, the video image 21 is projected onto the ceiling 17 at a position that is offset from the projector 12. Advantageously, the projection system 10 is compact in size, easy to operate, and enables a high quality video image projected on either a wall or ceiling surface. Further, the projector 12 is easily portable and storable.

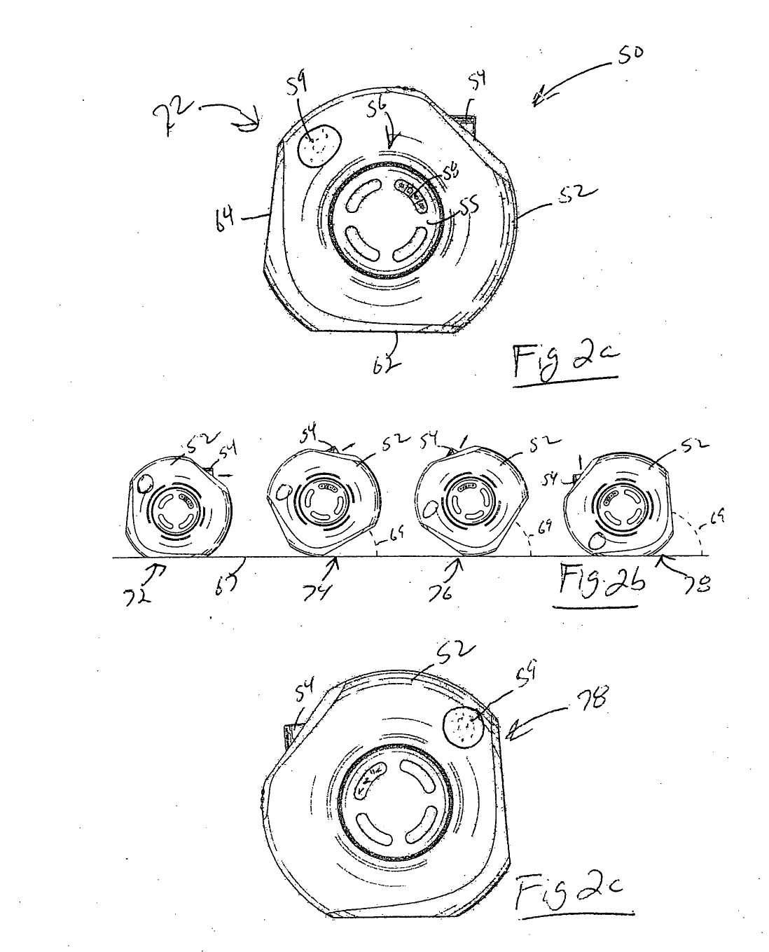

Referring now to FIG. 2, a projection system 50 is shown in more detail. The projection system 50 has a projector 52. Projector 52 has a projection lens 54 for directing a video beam to a viewing face. The projector 52 has an integrated video player in the form of a DVD player 56. It will be appreciated that other types of video players, such as a VHS system, could be substituted. However, the popularity and high quality available from the DVD makes it preferable as a video player source. The DVD 56 has a DVD cover 55 which may be selectably opened to load a DVD. It will be appreciated that other types of DVD players can be used, such as slot-loading DVD system or a tray loading DVD. DVD control buttons 58 are positioned on the DVD cover 55. To increase the ease of use of the system and yet enable a theater-like experience, the projector 52 also includes built in stereo speaker system. In this regard, each side of the projector 52 has a speaker for handling midrange and high range tones. For example, one side has a speaker for handling the left audio channel 59 and the other side has a speaker for handling a right audio channel 60 (not shown). It will be appreciated that an audio channel may support more than one speaker, such as a separate tweeter for high frequencies and one or more cone speakers for midrange and lower tones.

The video projector 52 is constructed to have two bases. A first base 62 is constructed to rest on a support surface 67 to orient the projector 52 to project a video image onto a vertical face such as a wall. The projector 52 has a second base 64 for resting on the support surface 67, which orients the projector 52 for projecting a video image onto a horizontal surface such as a ceiling. More particularly, the projector 52 may be placed in a first projection orientation for making a wall projection 72. The projector 52 may be physically rotated through a rotation angle 69 into rotation positions 74 and 76. Finally, when the projector 52 is fully rotated so that base 64 is resting on support surface 67, then the projector is in the second projection orientation, allowing for ceiling projection 78.

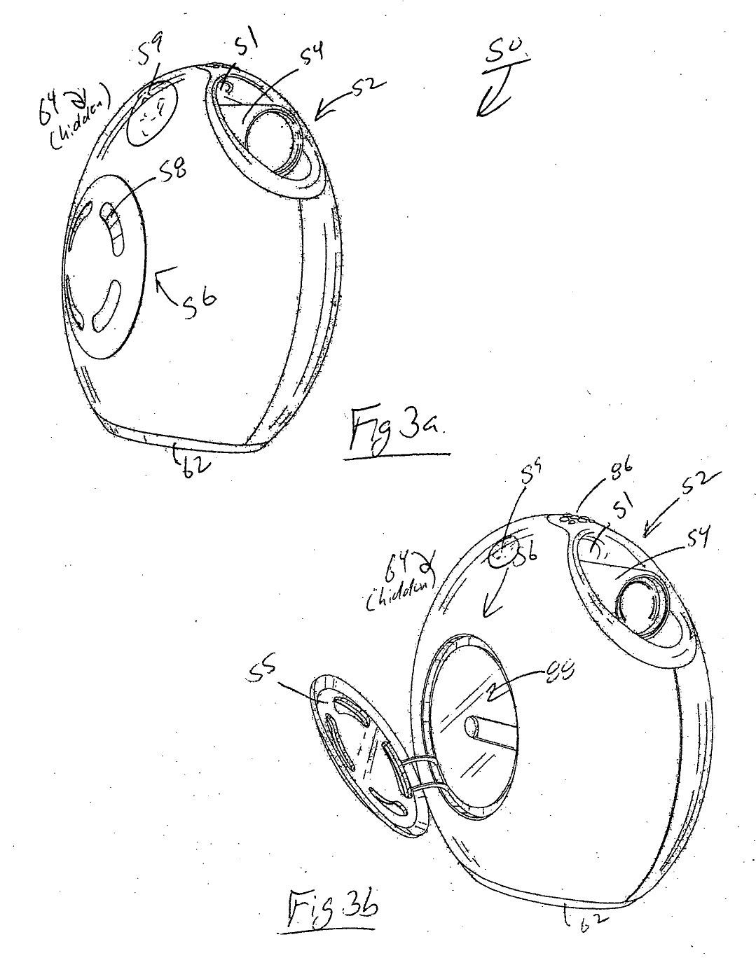

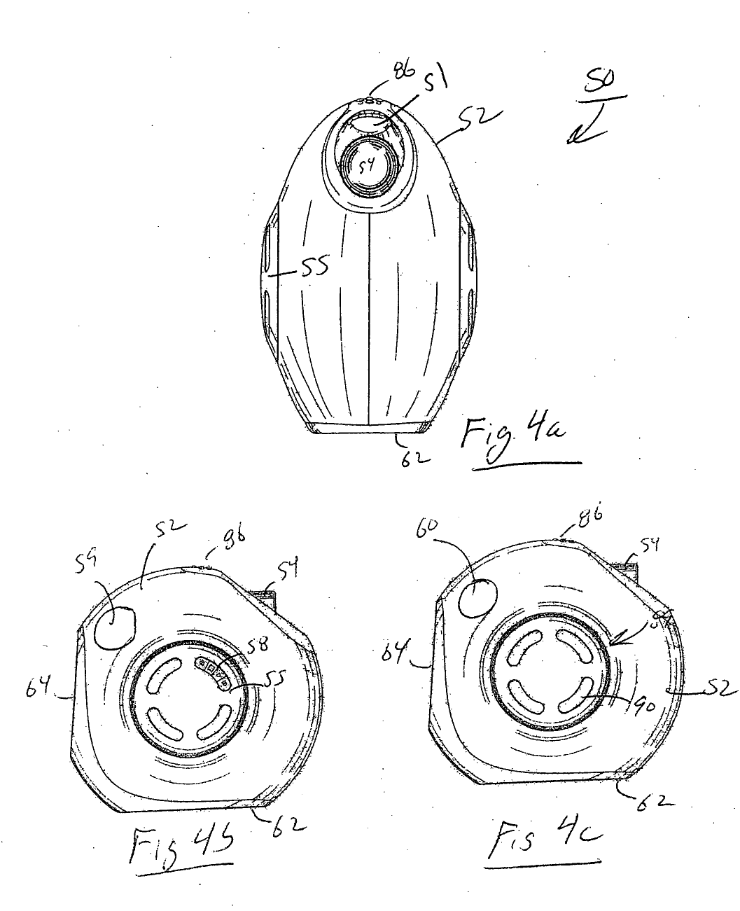

Referring now to FIGS. 3 and 4, a further description of the projection system 50 is shown. The projector 52 may be constructed as a unitary device with the DVD player 56 on one side and a subwoofer 89 on the other side. The subwoofer cooperates with the other audio speakers 59 and 60 for producing a high quality audio experience for the viewers and listeners. As shown, the ornamental aspects of the projector 52 are consistent from the left side and right side. For example, the ornamental aspects of the DVD cover 55, are generally duplicated for the subwoofer 89. However, the viewing windows and controls of the DVD have been replaced with an ornamental cover with windows 90. The internal cavity of the projector acts as a subwoofer cavity for developing good quality low frequency sounds. The subwoofer system includes a subwoofer port 51. Only one port is necessary, as low frequency sounds tend to be generally omni-directional. This subwoofer ports 51 enables the low frequency sounds of the subwoofer to be transmitted from the projector 52. In one example of the projector 52, the subwoofer port 51 is also used as a ventilation port for assisting with the cooling of the internal illumination and electronics system. Also, the port 51 acts as part of a carrying handle when transporting the projector 52.

The DVD cover 55 may be moved to an open position to reveal a DVD loading area 88. Once a DVD is loaded into the loading area 88, the DVD cover 55 may be closed and then the DVD controls 58 used to initiate play. Additional controls may be provided on the projector 52. For example, video controls 86 may be provided conveniently at the top of the unit for enabling the user to make certain selections for the video projector. For example, the user may be asked to select between available aspect ratios, adjust brightness, adjust audio features, or make other adjustments to the theater experience.

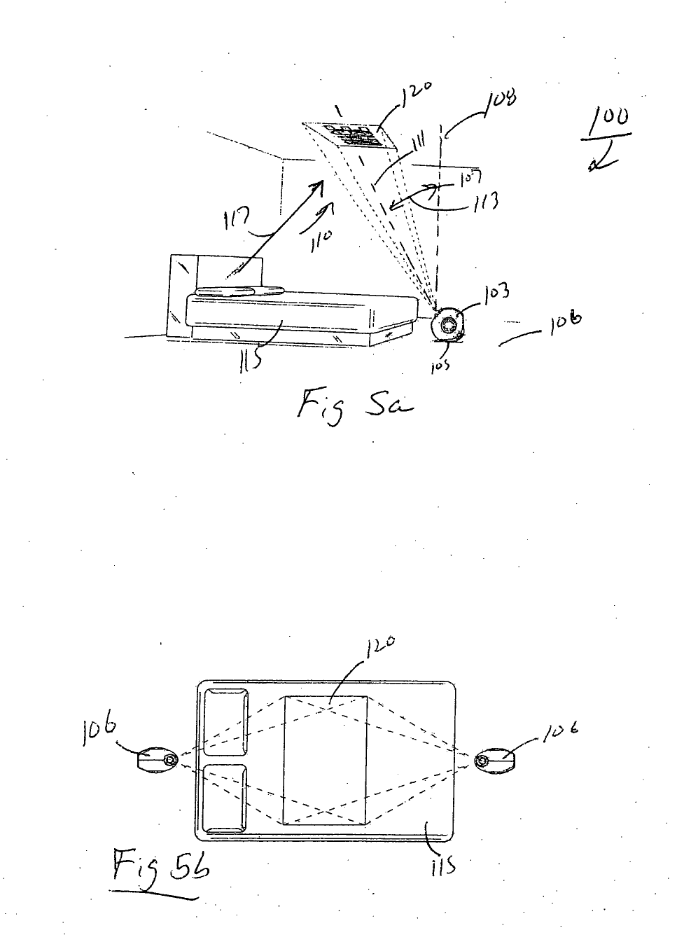

Referring now to FIG. 5 a video projection system 100 is shown. The projector 103 is shown in a second orientation where the second base 105 is resting upon the floor 106. For reference purposes only, a vertical line 107 is drawn orthogonal from the floor 106. The projection lens projects a video beam 110 along a projection axis 111. In this way a video image 120 is projected onto the ceiling 108. The projection axis 111 is offset from the reference line 107 by a setoff angle 113. The setoff angle 113 is sufficient so that the projector 103 can project the image 120 offset from the projector to enable easier viewing. It will be appreciated that the offset angle can be selected to support specific viewer requirements. For example, the offset angle may be selected with the assumption that many users will set the projector on the floor, and will project an image over their bed onto an 8-foot high ceiling. Other assumptions may lead to the selection of a different offset angle.

Referring to FIG. 5A, the projector 105 is shown resting on the floor 106 at the foot of a bed 116. The offset 113 is sufficient so that the projection axis 111 enables the image 120 to be projected directly over the bed. In this way the line of view 117 for a viewer laying on the bed is more comfortable. Since some room configurations may not permit a projector to be placed at the foot of a bed, the projector may be arranged at the head of the bed as shown in FIG. 5B. In order to be placed at the head of the bed, the projection system would have a video control enabling the flipping of the video image 180 degrees to project the image in the correct orientation for viewing. Although the projector is shown on the floor at the foot of the bed, it will be appreciated that the projector may also be set on an elevated stand, such as a night stand or on the book case associated with the bed.

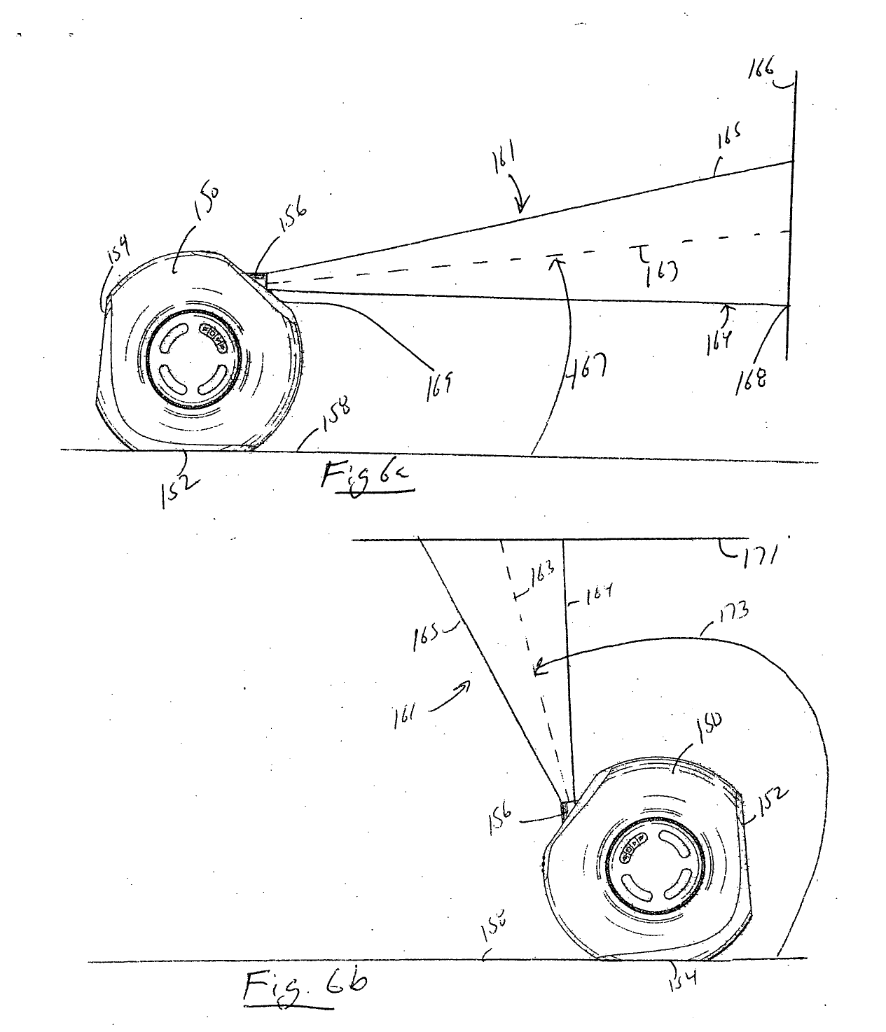

Referring now to FIG. 6 a projector 150 is shown in two orientations. The first orientation is shown in FIG. 6A with the projector arranged to project onto a wall, and the second orientation is shown in FIG. 6B where the projector is arranged to project onto a ceiling. In the first orientation the projector 150 is arranged so that base 152 rests upon the support surface 158. The projection lens 156 thereby projects a video beam 161 along a projection axis 163. The projection axis 163 is at an offset angle 167. The offset angle 167 is sufficient such that the edge of the video beam 164 projects at a height at the wall 168 that is at least as high as the height of the lens 169. The other edge of the video beam 165 is projected much higher onto the wall 166. The offset angle 167 allows the video image to be projected higher up on the wall without having viewing interference from the projector 152. Also, the offset angle facilitates the ease of transition into the second orientation. As shown in FIG. 6A, the offset angle 167 is set at about 10 degrees as measured from the support surface 158. It will be appreciated that other offset angles may be used consistent with the disclosed projection system. For example, a steeper offset angle will position the image higher on the wall. It will also be appreciated that the projector may allow for viewer-selectable offset angles.

It is understood, however, that projecting an image using an offset angle will produce certain distortions such as keystoning in the displayed image. To minize the impact of such optical distortions the video projector 152 has optics arranged to compensate for expected distortions. Details of the optic system are described in a later section. It will be appreciated that the construction and arrangement of an optic system, including compensation techniques, are well understood and therefore will only be generally addressed.

Referring now to FIG. 6B, the projector 150 is shown in a second orientation. In the second orientation the second base 154 is resting on the floor support surface 158. The projection lens 156 is now positioned to project the video beam 161 along a projection axis 163. In the example shown in FIG. 6B, the second base 164 is constructed to cause the projector 150 to project the video image at an even further offset from the projector. This is done to enable the video projector 150 to project a video image over, for example, a bed for easier viewing. It will be appreciated that the amount of offset can be easily adjusted by setting the specific angle between the support base 154 and the support surface 158. In an alternative, the offset angle may be adjusted using an internal mechanism (not shown) that is constructed to rotate the source screen (LCD panel) to maintain a parallel orientation with the projection face. As shown in FIG. 6B, the offset angle 173 is set at about 115 degrees as measured from the support surface 158. It will be appreciated that other offset angles may be used consistent with the disclosed projection system.

The projector 150 is shown with a housing having two external support bases for providing the flexible orientation of the projector 152. It will be appreciated that other external or internal structures may alternatively provide such flexibility. For example, the video projector may be constructed with the outside housing having a single base contacting the support surface, and an internal structure for rotating the projection lens and optical system into a new orientation. In this arrangement the projector would preferably have stops for aligning the projector into a first orientation for projecting onto a wall, and a second orientation for projecting onto a ceiling. Other stops could be provided. Such an arrangement would have an advantage of enabling a viewer to make adjustments as to a particular projection axis to facilitate more precise placement of the viewing image. However, using a projection angle that is not preselected may cause additional distortions on the viewing image. Although it may add cost and complexity to the unit, it may be therefore desirable to add a variable distortion adjustment if a more flexible orientation mechanism is used. The distortion control mechanism could be optical, electrical, or a combination of both.

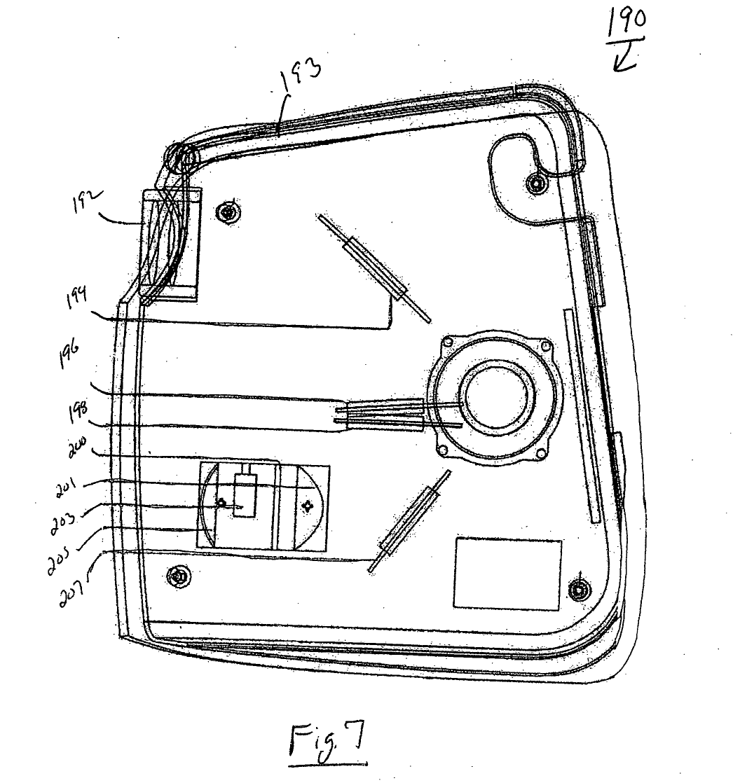

Referring now to FIG. 7, the optical system employed in the projection system is more fully described. FIG. 7 illustrates a projector 190 having a housing 193. A lamp 203 is an illumination source generating light. The lamp may be a commonly available incandescent projector bulb, which is both affordable and easy to replace. A reflector 205 enables more of the light to pass through the IR filter 200 and into the lens 201. The lens 201 concentrates and directs the light into a light beam. The light beam reflects off mirror 207 and passes through Fresnel lens 198 and through the source screen. The source screen may be an LCD panel 196, and preferably is a TFT LCD panel. The LCD panel is driven by video circuitry for adding video information to the light beam. The video beam then reflects off mirror 194 and is directed into the lens projection assembly 192. The lens projection assembly 192 provides focusing and other adjustment for specific viewing arrangements. The projector 190 uses mirrors 207 and 194 to construct a compact and efficient light engine.

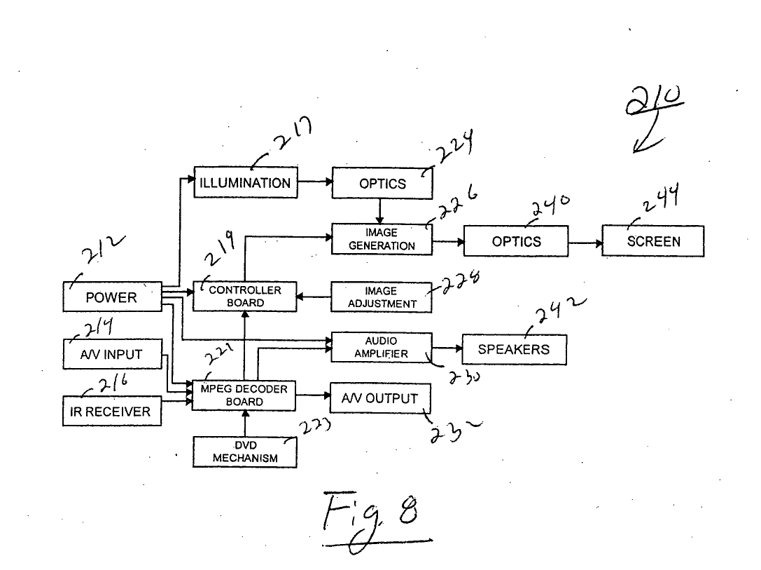

Referring now to FIG. 8, a block diagram of a video projector is shown. The video projector has a power supply 212 for powering the unit. Preferably the power supply connects to household power. Alternatively, a battery system may be utilized, although a battery system would have limited life due to the power requirements of the lamp, DVD system, and electronics. To increase battery life in a battery-powered unit, the projector may use an LED system for illumination.

The projection unit may also have an optional audiovisual input 214, for providing inputs from an external source. For example, a user may desire to hook up an external VHS system or a video camera to the video projector. In another optional arrangement, the projector may have an integrated TV tuner for receiving broadcast, cable, or satellite TV transmissions. In this way, the projector could function as a large-format projecting television set.

An audiovisual input may be wirelessly connected to a household wireless network. In this way an external computer system could drive the video or digital images for projection. Such a wireless system could be for example, a wireless 802.11a connection. In another use for the video projector, the audio-video inputs could accept an input from an external gaming device, such as a video game or internet-base game. In a similar manner, the audiovisual output may be constructed wirelessly. For example, the audio output could be an FM transmitter, which would enable a viewer to listen to audio content through an existing home FM receiver system, or to receive the FM broadcast in a portable stereo device.

The video projector may also have an infrared receiver 216 for receiving infrared commands from a remote control. The infrared receiver could be positioned adjacent the projection lens. In this way, a user may direct a remote control beam towards the video image on the wall or ceiling, and the infrared beam would be reflected into the IR receiver for controlling the video projector. The DVD 223 provides a video source into a decoder board 221. The decoder board passes audio information into an audio amplifier 230 and passes the video image into a controller board 219. Optionally, the decoder board 221 may also drive an audiovisual output 232 for driving an external video signal.

The controller board may act responsive to an image adjustment 228. Adjustment 228 may include automatic image adjustment or may be responsive from user input, for example, from the video controls. Such image adjustments could be, for example, selection of aspect ratio, brightness, contrast, color saturation, or other characteristics of the video beam. The control board 219 passes the video information to an image generation block 226 where the image is created. The image generation 226 may be accomplished on a source screen, such as an LCD. It will be appreciated that other technologies exist for supporting image generation on a source screen, such as liquid crystal on silicon (LcoS), digital light processing (DLP), and even miniature CRT structures. It will be appreciated that these technologies may require modifications to the light engine or optical system.

The lamp provides illumination in block 217, with the light passing through optics 224. The light is then directed through the source screen 227 and into a further optical system 240. Optics 240 includes the projection lens previously discussed. The video image is then projected onto a viewing face such as a screen 244, a wall, or a ceiling.

A lamp may provide the illumination 217. Since the projector is constructed primarily for residential use, a relatively low lumen bulb may be used. For example, a commonly available incandescent projector bulb having a lumen rating around 6000 may be used. Such a bulb is generally readily available, moderately priced, and easy to replace. It will be appreciated that bulbs with other lumen ratings may be substituted.

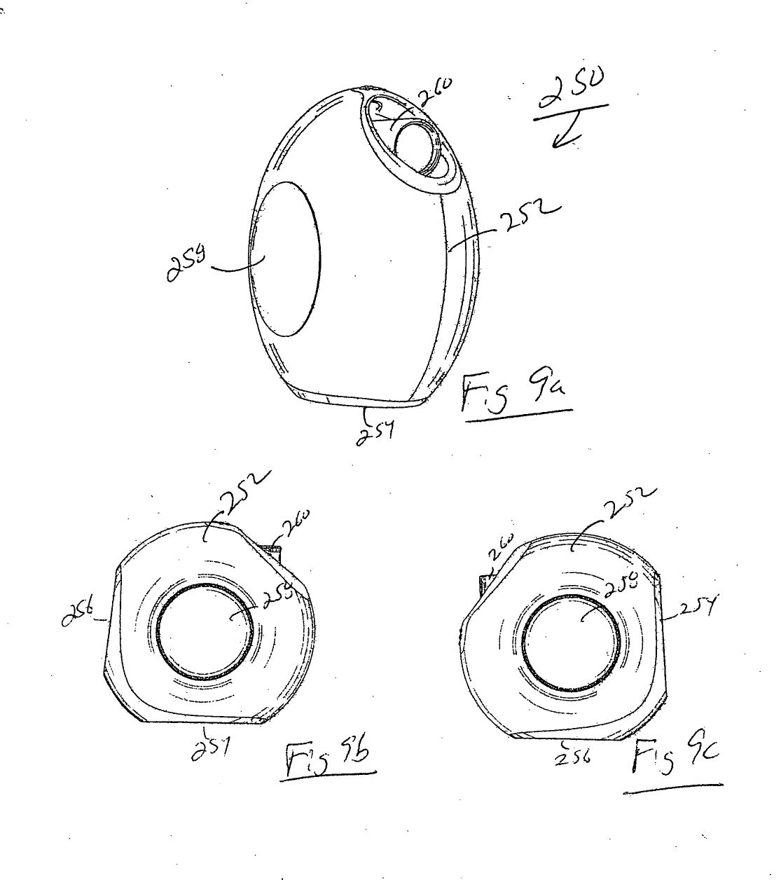

Referring now to FIG. 9 another example of the video projector system 250 is shown. Video projection system 250 has a projector 252 having a first base 254 and a second base 256. As with previously described projectors, the first base 254 and the second base 256 are constructed to position the projection lens 260 into different viewing orientations. In this regard, projector 252, is like previous projectors except it does not have integrated DVD and integrated sound. Instead, the DVD and subwoofer covers have been replaced with decorative covers 258. Projector 252 would therefore need an video input for accepting a video signal from an external device. In one example, the video input is a wireless video input. In this way, a home entertainment system having a high quality video source could wirelessly transmit a video signal to the video projector 252. The video projector could then project the video image onto the wall or ceiling. In another example, the projector 252 has an integrated TV tuner for projecting broadcast, cable, or satellite TV programs.

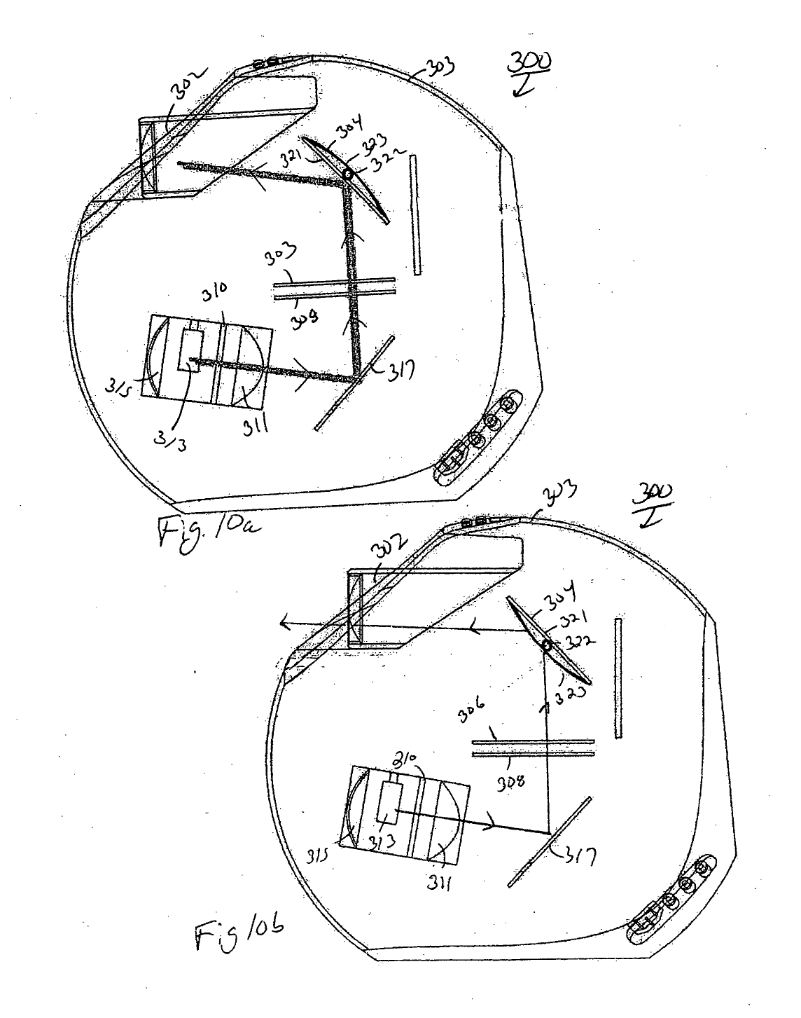

Referring now to FIG. 10, another example of a video projector is shown. Video projector 300 enables a viewer to optically change the aspect ratio of the projected video image. This is desirable to facilitate matching the projected image to the aspect ratio of the source video signal, and may also permit a more desirable projected image. For example, if a video image is projected onto a ceiling with a large offset angle, the video image is likely to have a noticeable keystoning effect, which makes the projected image appear less rectangular and more trapezoidal. By using a wider aspect ratio (such as 16:9), the perceived trapezoidal distortion to the left and right sides of the image is significantly reduced. In another example, a viewer may choose to view a video image in 4:3 format, irrespective of the source material aspect ratio, since the 4:3 format provides a particularly efficient light engine arrangement. In this way, a brighter image is projected, facilitating viewing the video image in brighter ambient conditions.

FIG. 10 illustrates a projector 300 having a housing 303. A lamp 313 is an illumination source generating light. The lamp may be a commonly available incandescent projector bulb; which is both affordable and easy to replace. A reflector 315 enables-more of the light to pass through the IR filter 310 and into the lens 311. The lens 311 concentrates and directs the light into a light beam. The light beam reflects off mirror 317 and passes through Fresnel lens 308 and through the source screen. The source screen may be an LCD panel 306, and preferably is a TFT LCD panel. The LCD panel is driven by video circuitry for adding video information to the light beam. The video beam then reflects off mirror 304 and is directed into the lens projection assembly 302. The lens projection assembly 302 provides focusing and other adjustment for specific viewing arrangements. The projector 190 uses mirrors 317 and 304 to construct a compact and efficient light engine.

In projector 300, the mirror 304 is constructed to rotate around a pivot point 323. One side of the mirror 304 is generally flat 321, while the other side is generally curved as a convex reflector 323. More specifically, the convex surface is convex along one axis, with the other axis remaining generally flat. This produces a generally cylindrical shape for the convex surface. It will be appreciated that the convex surface may deviate from the cylindrical shape to accommodate specific light engine requirements. For example, the convex surface may not have a constant radius, or the generally flat axis may have a slight curve. Designing and constructing a reflecting surface with such deviations are within the capabilities of one skilled in optic systems.

When the mirror 304 is positioned with the flat side 321 in the light path, a video image is projected having an aspect ration of 4:3. When the mirror 304 is positioned with the convex side 323 in the light path, the same video image is projected having an aspect ratio of 16:9. In this way, the projected aspect ratio may be adjusted optically, which avoids signal degradation and artifacts that may be introduced by changing aspect ratio using electronic circuitry. It will be appreciated that other aspect ratios may be selected by modifying the construction or arrangement of the mirrors 317 and 304.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

1. A video projector, comprising:
a housing resting on a support surface;
a first base constructed to orient a projection lens along a first projection axis;
a second base constructed to orient the projection lens along a second projection axis;
wherein the first projection axis is about orthogonal to the second projection axis;
a video device providing the video projector with a video signal;
video circuitry arranged to generate image information on a source screen; and
a lamp and optics arranged to project a video beam onto a viewing surface, the video beam being indicative of th e image information.

2. The video projector of claim 1, wherein the first base and the second base are constructed on the outside of the housing, the first base and the second base being about orthogonal.

3. The video projector of claim 1, wherein the first base and the second base are constructed on the inside of the housing, the first base and the second base being about orthogonal.

4. The video projector of claim 1, wherein the video device is a video player inside the housing.

5. The video projector of claim 4, wherein the video device is a DVD player.

6. The video projector of claim 1, wherein the lamp is an incadencent bulb.

7. The video projector of claim 6, wherein the incadencent bulb outputs less than 7000 lumens.

8. The video projector of claim 1, wherein the first projection axis is set off at an angle of about 5 degrees to about 20 degrees relative to the support surface.

9. The video projector of claim 8, wherein the optics are arranged to compensate for distortion effects resulting from the set off angle.

10. The video projector of claim 8, wherein the video circuitry is arranged to compensate for distortion effects resulting from the set off angle.

11. The video projector of claim 1, wherein the second projection axis is set off at an angle of about 95 degrees to about 110 degrees relative to the support surface.

12. The video projector of claim 11, wherein the optics are arranged to compensate for distortion effects resulting from the set off angle.

13. The video projector of claim 11, wherein the video circuitry is arranged to compensate for distortion effects resulting from the set off angle.

14. The video projector of claim 1, wherein the source screen is an LCD panel.

15. The video projector of claim 1, wherein the optics are arranged to be adjusted to support a first aspect ratio or are arranged to support a second aspect ratio.

16. The video projector of claim 15, where the first aspect ratio is 4:3 and the second aspect ratio is 16:9.

17. The video projector of claim 1, wherein the optics includes a mirror, the mirror constructed to be generally convex on one axis, and arranged to reflect the video beam at an adjusted aspect ratio.

18. The video projector of claim 17, wherein the mirror is constructed to adjust a 4:3 video beam into a 16:9 video beam.

19. The video projector of claim 17, where the mirror has a flat surface that can be selected to reflect the video bean at an unadjusted aspect ratio.

20. A video projector, comprising:
a housing resting on a support surface;
a first base constructed to orient a projection lens along a first projection axis;
a second base constructed to orient the projection lens along a second projection axis;
wherein the first projection axis is about orthogonal to the second projection axis;
a TV tuner providing the video projector with a video signal;
video circuitry arranged to generate image information on a source screen; and
a lamp and optics arranged to project a video beam onto a viewing surface, the video beam being indicative of the image information.
